(19) United States
(12) Patent Application Publication
(10) Pub. No.: US 2012/0307890 A1
(43) Pub. Date: Dec. 6, 2012

(54) TECHNIQUES FOR ADAPTIVE ROUNDING OFFSET IN VIDEO ENCODING

(75) Inventors: Mei-Hsuan Lu, Bellevue, WA (US); Ming-Chieh Lee, Bellevue, WA (US)

(73) Assignee: MICROSOFT CORPORATION, Redmond, WA (US)

(21) Appl. No.: 13/152,108

(22) Filed: Jun. 2, 2011

(51) Int. Cl. H04N 7/26

(52) U.S. Cl. 375/240.03; 375/E07.127

(57) ABSTRACT

Techniques adaptive rounding offset in video encoding are described. An apparatus may comprise a rounding offset adaptation component operative to adjust a quantization parameter rounding factor for a current macroblock of a current frame of a video stream being compressed by a video encoding system. Other embodiments are described and claimed.

### BACKGROUND

The digital transmission and storage of video data with lossy compression has become an overwhelmingly dominant method of managing video. As is well known, the fundamental goal in lossy video compression is to minimize the distortion of the image while maximizing the degree of compression achieved, which is to say, maximizing the visual quality of the video while minimizing the bit rate of the video data stream. Further, numerous methods of video delivery—from streaming on video sharing sites to downloading from digital video stores to storage on physical media—place a limit on the allowable bit rate of a video data stream. This creates a demand for video compression which can not only minimize distortion, but do so while making efficient use of a bit rate budget. However, existing tools for addressing this problem can be computationally expensive, particularly those which require multiple passes to determine key values which guide the compression process. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for adaptive rounding offset in video encoding. Some embodiments are particularly directed to techniques for adaptively adjusting the rounding offset of a quantization parameter as used by a quantization/scaling component for more accurate rate control. In one embodiment, for example, an apparatus may comprise a rounding offset adaptation component operative to adjust a quantization parameter rounding factor for a current macroblock of a current frame of a video stream being compressed by a video encoding system. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system for video encoding with adaptive rounding offset.

FIG. 2A illustrates an embodiment of a first logic flow for the system of FIG. 1.

FIG. 2B illustrates an embodiment of a second logic flow for the system of FIG. 1.

FIG. 3 illustrates an embodiment of a centralized system for the system of FIG. 1.

FIG. 4 illustrates an embodiment of a distributed system for the system of FIG. 1.

FIG. 5 illustrates an embodiment of a computing architecture.

FIG. 6 illustrates an embodiment of a communications architecture.

### DETAILED DESCRIPTION

Various embodiments are directed to techniques for adaptive rounding offset in video encoding. Various video encoding techniques rely on a quantization function to map a large input domain to a smaller output range. Because the output range is smaller than the input domain, fewer bits are needed to represent all of the possible values of the output range than the input domain, though quantization error may be introduced as multiple input values may be mapped to the same output value. Applying the quantization function to data values within a video encoding system, therefore, produces output values which represent the data values using less bits, allowing for compression, though the introduced quantization error results in a potential loss of image quality. In order to reduce the loss of image quality, as little quantization as possible should be used during video compression. However, greater quantization will typically result in greater levels of compression. As such, video encoding systems strive to determine their degree of quantization, as described by a quantization parameter, in a manner that maximizes the quality of an image while fitting the compressed video within a bit rate budget. For instance, video streaming sites, digital video download stores, and video storage on physical media may all present limitations on the acceptable bit rate of an encoded video. A video streaming site may be limited by a maximum acceptable sustained transfer rate. A digital video download store may be limited by a maximum acceptable file size for digital videos. Physical media may be limited in its maximum capacity, and any video stored on that media is therefore limited in its maximum acceptable bit rate in order to fit on the physical media.

Various video encoding techniques may rely on a quantization function in which values from the input domain are linearly or logarithmically reduced to a lesser value through division and then rounded to an adjacent member of the output range. For example, given an input domain of {0,1,2,3,4,5,6,7,8,9,10} and an output range of {10,1,2,3,4,5}, each input value might be halved and then rounded to the next lowest member of the output range, such that both of {0,1} are mapped to {0}, both of {2,3} are mapped to {1}, and so on. It will be appreciated that a variety of rounding factors may be used to determine how values being quantized are rounded to an adjacent member of the output range. Consider that a quantization process may have a quantization step size which corresponds to the numerical distance between adjacent values of the output range. A quantization parameter rounding factor may comprise a fraction representing what portion of the quantization step size is rounded downwards to the nearest lower value in the output range, with the remaining portion of the quantization step size rounded upwards to the nearest higher value in the output range. It will be appreciated that a larger quantization parameter rounding factor will result in more values in the input domain being mapped to lesser values in the output range, and a lesser quantization parameter rounding factor will result in fewer values in the input domain being mapped to lesser values in the output range.

In various existing video encoding techniques a constant quantization parameter rounding factor may be used. In particular, in the H.264 standard for video compression—alternatively referred to as MPEG-4 Part 10 or the Advanced Video Coding (AVC) standard—two constants are typically used as the quantization parameter rounding factor. In video encoding, an intra macroblock may refer to a macroblock of video data encoded using only the video data of macroblocks belonging to the current frame, as well as the various constants and variables which inform the encoding scheme, without reference to the video data of any other frame. A macroblock encoded as an intra macroblock may be said to have been encoded using intra prediction by an encoder operating in intra mode. An inter macroblock may refer to a macroblock of video data encoded with reference to the video data of macroblocks belonging to frames other than the current one, in addition to the various constants and variables which inform the encoding scheme. A macroblock encoded as an inter macroblock may be said to have been encoded using inter prediction by an encoder operating in inter mode. In particular, in the H.264 standard there are I-macroblocks encoded using intra prediction, P-macroblocks encoded using inter prediction referencing at most one other macroblock belonging to another frame, and B-macroblocks referencing at most two other macroblocks belong to another frame or frames. Therefore, in the H.264 standard, I-macroblocks are encoded in the intra mode while P-macroblocks and B-macroblocks are encoded in the inter mode. In various implementations for H.264, a first constant quantization parameter rounding factor is used for macroblocks encoded in the intra mode and a second constant quantization parameter rounding factor is used for macroblocks encoded in the inter mode.

In contrast, various embodiments are directed to techniques for adaptive rounding offset in video encoding. In various embodiments, rather than using a constant quantization parameter rounding offset, or a quantization parameter rounding offset determined solely by the encoding mode, the quantization parameter rounding offset may be dynamically adjusted so as to increase coding efficiency, reducing the output bit rate, while maintaining approximately the same level of rate distortion performance, thereby maintaining output image quality. In various existing encoding techniques, such as H.264, quantization is applied to the transformed residuals of a motion estimation/motion compensation process. Motion compensation refers to a technique in which a subject image is described in terms of a transformation from a reference image to the subject image. Motion estimation refers to a technique in which motion vectors are determined which carry out the transformation of the reference image to the subject image. In various encoding techniques, motion compensation and motion estimation are used to describe a macroblock in terms of a transformation from one or more other macroblocks. For example, consider a video which depicts a car moving from the left side of the depicted area to the right side of the depicted area. A video encoder attempting to encode the video may encode a particular macroblock which contains a portion of the car in the current frame with reference to a macroblock that contained that same portion of the car in a previous frame, despite those macroblocks having different absolute positions in the frame due to the motion of the car between frames. However, this transformation may be imperfect, in that while the macroblock in the current frame may be highly similar to the macroblock from the previous frame, it may not be identical. The differences between the macroblocks may be referred to as the residuals of the transformation from the previous macroblock to the current macroblock. These residuals may therefore represent the difference between the current and previous macroblock which do not merely represent the motion of the macroblock as described by a motion vector. In various existing encoding techniques, it is these residuals which are transformed and quantized. It will be appreciated that if a portion of the motion-compensated and motion-estimated macroblock is identical to the reference macroblock, that this portion may have zero-value coefficients input to the quantization process. It will be appreciated that this portion having zero-value input coefficients will have zero-value output coefficients. We may refer to the portion of the output from the quantization process having zero-value coefficients as the dead zone of the output. It will be appreciated that this dead zone may be represented using very few bits due to its entire contents having the same value of zero. Further, input coefficients near to zero will also be quantized to zero, including that portion of the macroblock in the dead zone, as determined by the quantization parameter rounding offset. As such, it will be appreciated that by adjusting the quantization parameter rounding offset, we may adjust the size of the dead zone of motion-estimated and motion-compensated macroblock. Because increasing the size of the dead zone will decrease the number of bits needed to encode the motion-estimated and motion-compensated macroblock, it will be appreciated that by increasing the quantization parameter rounding offset, and thereby increasing the input domain of values that will map to zero, that we can decrease the number of bits needed to encode the motion-estimated and motion-compensated macroblock and thereby decrease the output bit rate for the encoded macroblock. However, increasing the size of the dead zone increases the portion of the encoded image which is encoded using only reference to the reference frames, and thereby potentially decreases output image quality, increasing distortion. As such, it will be appreciated that dynamically adjusting the quantization parameter rounding offset may be used to adjust the balance between bit rate and distortion in the encoded video.

Adjusting the balance between bit rate and distortion in an encoded video through the dynamic adjustment of the quantization parameter rounding offset may be particularly advantageous due to the relative computational efficiency of this technique for adjusting bit rate as compared to existing techniques. Existing video encoding techniques, such as H.264, may determine a quantization parameter and a macroblock mode, intra mode or inter mode, for each macroblock. However, as is well known in the art, it may be difficult to determine both the optimal macroblock mode and optimal quantization parameter as the method for determining a quantization parameter for a given desired bit rate may be dependent on the choice of macroblock mode while the method for determining a macroblock mode for the given desired bit rate may be dependent on the choice of quantization parameter. As such, existing video encoding techniques may be limited to either performing multiple passes to determine the macroblock mode and quantization parameter or may estimate one to determine the other. However, while multiple passes may be used in which a starting quantization parameter is used to determine a macroblock mode, which is used in turn to determine a new quantization parameter, which is itself used in turn to determine a new macroblock mode, iterating in this fashion until the macroblock mode and quantization parameter converge to stable values, these multiple passes can greatly increase the time needed to determine the macroblock mode and quantization parameter and thereby increase the time needed for video encoding, reducing the computational efficiency of the encoding process, which is undesirable. Similarly, while quantization parameter may be determined through estimation, allowing for the selection of a macroblock mode on the basis of the determined quantization parameter, this quantization parameter, by being selected without knowledge of the macroblock mode, may result in a poor rate distortion optimization as the determined quantization parameter may result in a bit rate different than desired. In particular, scenes containing rapid variation in brightness or abrupt change of scene contents have been known to result in large bit rate control errors, such that the encoded image does not meet the desired bit rate restrictions. Adjusting the quantization parameter rounding offset, however, may allow for the image encoding to be fit within the desired bit rate restrictions, particularly through its ability to adjust the size of the dead zone, as previously discussed. As a result, the embodiments can improve the computational efficiency of a video encoding process while maintaining image quality and abiding by bit rate limitations, enhancing the rate distortion optimization process.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

Various portions of the preceding and following text make reference to macroblocks. The term “macroblock” as used herein may correspond to the use of the term “macroblock” in other video encoding techniques. However, various existing video encoding techniques, such as H.264, alternatively or additionally make reference to “blocks,” “slices,” and other terms for basic units of video encoding. It should be appreciated that the term “macroblock” as used herein may be applied to any basic unit of video encoding to which the enclosed techniques may be applied, particularly any basic unit for which a dynamic adjustment of a quantization parameter rounding factor may be advantageously applied during quantization.

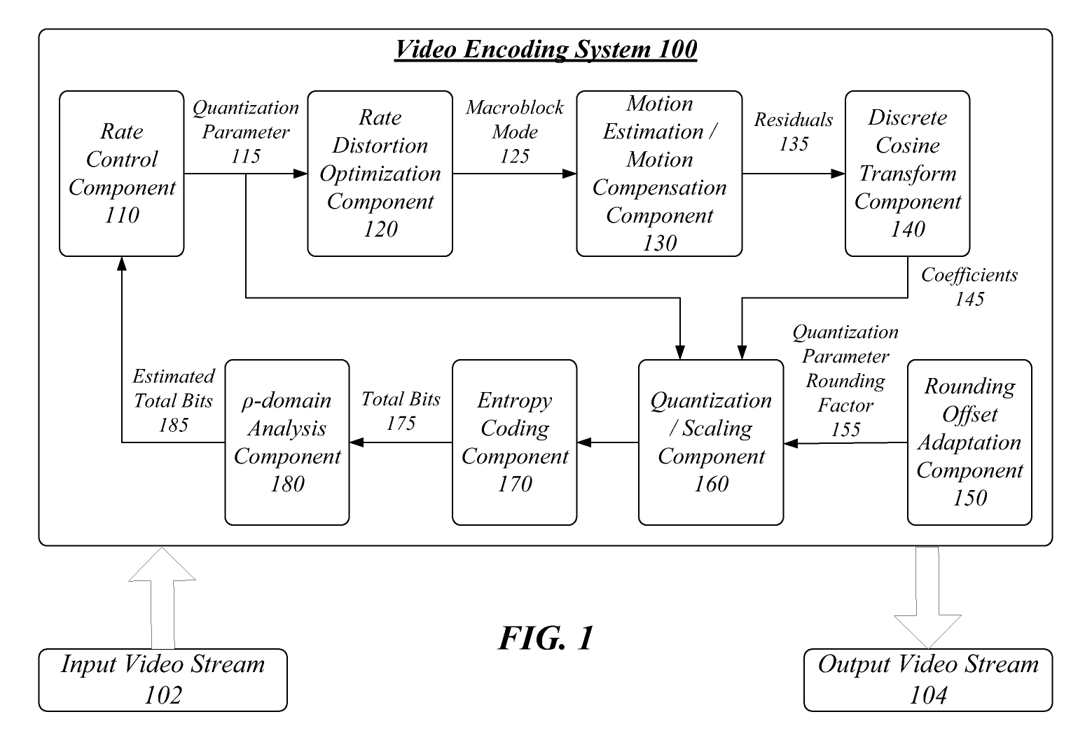

FIG. 1 illustrates a block diagram for a video encoding system 100. In one embodiment, the video encoding system 100 may comprise a computer-implemented video encoding system 100 having one or more software applications and/or components. Although the system video encoding system 100 shown in FIG. 1 has a limited number of elements in a certain topology, it may be appreciated that the video encoding system 100 may include more or less elements in alternate topologies as desired for a given implementation.

In the illustrated embodiment shown in FIG. 1, the video encoding system 100 includes a rate control component 110, a rate distortion optimization component 120, a motion estimation/motion compensation component 130, a discrete cosine transform component 140, a rounding offset adaptation component 150, a quantization/scaling component 160, an entropy coding component 170, and a ρ-domain analysis component 180. Video encoding system 100 receives input video stream 102 and produces output video stream 104, where output video stream 104 is an encoding of input video stream 102 according to the technique of video encoding system 100. The rate control component 110 is generally operative to determine a quantization parameter for use during the encoding of a macroblock. The rate distortion optimization component 120 is generally operative to determine a macroblock mode. The motion estimation/motion compensation component 130 is generally operative to determine a motion vector that describes the spatial transformation of a macroblock in reference to one or more macroblocks of a previously-encoded frame and to determine the residuals of the current macroblock remaining after the motion compensation. The discrete cosine transform component 140 is generally operative to determine coefficients based on received residuals. The rounding offset adaptation component 150 is generally operative to adjust or generate a quantization parameter rounding factor. The quantization/scaling component 160 is generally operative to quantize and scale the coefficients according to the quantization parameter and the quantization parameter rounding factor. The entropy coding component 170 is generally operative to perform entropy encoding. The ρ-domain analysis component 180 is generally operative to determine an estimated total bits for use by the rate control component. In various embodiments, the video encoding system 100 may be operative to receive one or more parameters. These parameters may comprise one or more model parameters, a bit rate budget for the encoding, and one or more user-defined parameters. These parameters may be specified at the initiation of the encoding process by a user in order to control the encoding process.

In various embodiments, the rate control component 110 may be operative to determine a quantization parameter 115 for use during the encoding of a macroblock. In various embodiments, a linear mean absolute difference (MAD) model may be employed to predict the coding complexity. Given a coding complexity and a target number of output bits, a quadratic rate-quantization model may be employed to calculate the quantization parameter 115. The quantization parameter 115 may be determined on the basis of one or more model parameters. In various embodiments, the model parameters may be iteratively adjusted by the rate control component 110 during the encoding of input video stream 102 in order to meet the bit rate budget of the video stream encoding process. The rate control component 110 may be operative to update the model parameters according to the quantization parameter and the number of output bits output during the encoding of the previous macroblock, total bits 175. Alternatively, the rate control component 110 may be operative to update the model parameters according to the quantization parameter and an estimated number of output bits as produced by the ρ-domain analysis component 180 during the encoding of the previous macroblock, estimated total bits 185. In various embodiments, the bit rate budget of the encoding may comprise a maximum sustained bit rate, a maximum peak bit rate, a maximum total bit size, or any other means of specifying a bit rate budget. In various embodiments, the bit rate budget of the encoding may be specified by a user as an input parameter to the encoding system. The rate control component may be operative to determine a bit rate budget for a current frame of the input video stream 102 being compressed by the video encoding system 100. The bit rate budget may comprise the target number of output bits for the current frame. The rate control component 110 may be operative to determine the bit rate budget for the current frame using the total bit rate budget for the encoding.

In various embodiments, the rate distortion optimization component 120 may be operative to determine a macroblock mode 125. In some embodiments, the macroblock mode may comprise one of an intra mode or an inter mode. An intra mode may comprise a mode using intra prediction, in which a macroblock is encoded using only the video data of that particular macroblock and previously-encoded macroblocks of the current frame, without reference to the video data of macroblocks belonging to any other frame except to the degree that the video data of those macroblocks has been used to generate or adjust the model parameters, the macroblock mode 125, the quantization parameter 115, the quantization parameter rounding offset 155, or any other parameter determined from the video data of another macroblock which does not encode the video data of that macroblock. In some embodiments, a macroblock encoded using intra prediction may be referred to as an I-macroblock. An inter mode may comprise a mode using inter prediction, in which the prediction of the frame is directly based on the video data of a macroblock belonging to another frame. In various embodiments, a macroblock encoded using inter prediction may be referred to as a P-macroblock or B-macroblock, in which a P-macroblock is encoded using inter prediction referencing at most one macroblock belonging to another frame and a B-macroblocks is encoded using inter prediction referencing at most two macroblocks belonging to another frame or frames. The rate distortion optimization component 120 may determine the macroblock mode 125 using the quantization parameter 115 in order to meet a particular bit rate budget.

In various embodiments, the motion estimation/motion compensation component 150 may be operative to determine a motion vector that describes the spatial transformation of a macroblock in reference to one or more macroblocks of a previously-encoded frame and to determine the residuals 135 of the current macroblock remaining after the motion compensation. The motion estimation/motion compensation component 150 may be operative to determine the motion vector and residuals 135 using the macroblock mode received from the rate distortion optimization component 120. In various embodiments, one or more well-known motion estimation/motion compensation techniques may be used to generate the motion vector and residuals 135.

In various embodiments, the discrete cosine transform component 140 may be operative to determine the coefficients 145 based on the received residuals 135. The coefficients 145 may comprise a transform coefficient array representing the residuals 135 in terms of the sum of cosine functions of different frequencies. In various embodiments, one or more well-known discrete cosine transform techniques may be used to generate the coefficients 145.

In various embodiments, the rounding offset adaptation component 150 may be operative to adjust or generate a quantization parameter rounding factor 155 for a current macroblock of a current frame of the input video stream 102 being compressed by the video encoding system 100. The rounding offset adaptation component 150 may be operative to adjust the quantization parameter rounding factor 155 in order to meet a bit rate budget, such as may have been determined by the rate control component 110. In various embodiments, the rounding offset adaptation component may be operative to adjust the quantization parameter rounding factor 155 in order to meet the bit rate budget by manipulating the size of a dead zone of the current macroblock. The rounding offset adaptation component may be operative to increase the size of the dead zone of the current macroblock by increasing the value of the quantization parameter rounding factor 155. The rounding offset adaptation component may be operative to decrease the size of the dead zone of the current macroblock by decreasing the value of the quantization parameter rounding factor 155. The dead zone of a macroblock may refer to the portion of the macroblock with zero-value coefficients after quantization.

In various embodiments, the rounding offset adaptation component 150 may be operative to select the quantization parameter rounding factor 155 from a specified list of possible quantization parameter rounding factors. The specified list of possible quantization parameter rounding factors may be determined by the macroblock mode 125 determined by the rate distortion optimization component 120. The list of possible quantization parameter rounding factors may be determined, additionally or alternatively, by the resolution of the frame being compressed. The list of possible quantization parameter round factors may comprise a plurality of values. If the frame being compressed is of a high resolution and the macroblock mode 125 is an intra mode then the list of possible quantization parameter rounding factors may be

$$\{ \frac{1}{3} , \frac{7}{24} , \frac{1}{4} , \frac{5}{24} \} .$$

It the frame being compressed is of a high resolution and the macroblock mode 125 is an inter mode then the list of possible quantization parameter rounding factors may be

$$\{ \frac{1}{6} , \frac{1}{8} , \frac{1}{12} , \frac{1}{24} \} .$$

If the frame being compressed is of a low resolution and the macroblock mode 125 is an intra mode then the list of possible quantization parameter rounding factors may be

$$\{ \frac{1}{3} , \frac{7}{24} , \frac{1}{4} \} .$$

If the frame being compressed is of a low resolution and the macroblock mode 125 is an inter mode then the list of possible quantization parameter rounding factors may be

$$\{ \frac{1}{6} , \frac{1}{8} , \frac{1}{12} \} .$$

In various embodiments, a high resolution may comprise any resolution greater or equal to the video graphics array (VGA) resolution of 640×480 pixels. In various embodiments, a low resolution may comprise any resolution lesser or equal to the common intermediate format (CIF) resolution of 352×288 pixels. These specified lists of possible quantization parameter rounding factors have been determined as an efficient mode of operation of the enclosed embodiments as determined through experimentation with different quantization parameter rounding factors.

In various embodiments, the quantization parameter rounding factor 155 for all macroblocks of the current frame may be equal to the average quantization parameter rounding factor for the previous frame if the quantization parameter for the current frame is equal to a quantization parameter for the previous frame plus or minus a specified maximum quantization parameter adjustment value. In various embodiments, the maximum quantization parameter adjustment value may be specified as a user input to the encoding process or may be a value hard-coded into the video encoding system 100.

In various embodiments, the rounding offset adaptation component 150 may use a previous quantization parameter rounding factor to adjust the quantization parameter rounding factor 155. The previous quantization parameter rounding factor may comprise the quantization parameter rounding factor used for compressing the macroblock immediately previous to the current macroblock. The rounding offset adaptation component 150 may use a number of preceding macroblocks to adjust the quantization parameter rounding factor 155. The number of preceding macroblocks may comprise a count of how many macroblocks from the current frame have already been compressed at the time that the current macroblock is being analyzed by the rounding offset adaptation component 150. The rounding offset adaptation component 150 may use a total number of output bits generated during compression of already-compressed macroblocks from the current frame. The rounding offset adaptation component 150 may use a total number of macroblocks for the current frame. The rounding offset adaptation component 150 may use a first user-defined parameter and second user-defined parameter.

In various embodiments, if the total number of output bits generated during compression of already-compressed macroblocks from the current frame plus the first user-defined parameter is less than the number of preceding macroblocks multiplied by the target number of output bits divided by the total number of macroblocks for the current frame then the quantization parameter rounding factor is selected from a specified list of possible quantization parameter rounding factors such that the selected quantization parameter rounding factor is next-smallest with respect to the previous quantization parameter rounding factor. It will be appreciated that this is effectively a comparison between the number of output bits used so far for the encoding of the current frame and an estimated number of output bits that should have been used so far for the encoding of the current frame. If the actual output bits used is less than the estimated target then additional capacity exists in the bit rate budget for the current macroblock and any remaining macroblocks in the current frame. As such, the next-smallest quantization parameter rounding factor is used, decreasing distortion from the quantization as previously discussed. The first user-defined parameter is added to the actual output bits used to prevent the bit rate usage from being increased unless a sufficient buffer of additional output bits are available in the bit rate budget.

In various embodiments, if the total number of output bits generated during compression of already-compressed macroblocks from the current frame plus the second user-defined parameter is greater than the number of preceding macroblocks multiplied by the target number of output bits divided by the total number of macroblocks for the current frame then the quantization parameter rounding factor is selected from the specified list of possible quantization parameter rounding factors such that the selected quantization parameter rounding factor is next-largest with respect to the previous quantization parameter rounding factor. It will be appreciated that, as before, this is effectively a comparison between the number of output bits used so far for the encoding of the current frame and an estimated number of output bits that should have been used so far for the encoding of the current frame. If the actual output bits used is greater than the estimated target then the bit rate budget may be being used faster than desired, which may require the current macroblock and any remaining macroblocks in the current frame to be encoded using less bits in order to meet the bit rate budget. As such, the next-largest quantization parameter rounding factor is used, decreasing the bits needed to store the quantized coefficients as previously discussed. The second user-defined parameter is added to the actual output bits used to prevent the bit rate usage from being decreased unless a sufficient demand of output bits is needed to meet the bit rate budget.

In various embodiments, if neither of the preceding conditionals is true, then a default quantization parameter rounding factor is used if the current macroblock is the first macroblock of the current frame and the current frame is the first frame of the video stream, and the previous quantization parameter rounding factor is used otherwise. It will be appreciated that this may allow for quantization to proceed at the current balance between bit rate and distortion by not changing the quantization parameter rounding factor as the actual number of output bits used is within an acceptable range of bit range usage as determined by the estimated number of output bits and the first and second user-defined parameters.

Expressed alternatively, the selected quantization parameter rounding factor 155 is selected according to the following series of three conditions, in which during the encoding of macroblock j in frame i, f(i,j) is the quantization parameter rounding factor used for macroblock j in frame i, b(i,j) is the number of output bits generated for the first j macroblocks in frame i, N is the total number of macroblocks in a frame, B is the target number of output bits, f_{default} is the default quantization parameter rounding factor, δ₁ is the first user-defined parameter, and δ₂ is the second user-defined parameter: if

$$b ( i , j ) + {δ}_{1} < \frac{j}{N} \times B$$

then use the quantization parameter rounding factor that is next smallest with respect to f (i, j) for j>0 and f (i−1, N−1) for j=0; if

$$b ( i , j ) + {δ}_{2} > \frac{j}{N} \times B$$

then use the quantization parameter rounding factor that is next greatest with respect to f (i, j) for j>0 and f (i−1, N−1) for j=0; otherwise, use f_{default} for i=j=0, use f (i, j−1) for j>0, and use f (i−1, N−1) for j=0, and i>0

In various embodiments, the quantization/scaling component 160 may be operative to quantize and scale the coefficients 145 according to the quantization parameter 115 and the quantization parameter rounding factor 155. In various embodiments, the quantization may comprise one or more well-known quantization techniques. In various embodiments, the quantization may be defined by the following equations, in which W_{i,j} is the coefficients 145, W_{i,j}′ is the output of the quantization/scaling component 160, QP is the quantization parameter of the current macroblock, and Qstep is the quantization step size:

$${W}_{i , j}^{′} = round ( \frac{{W}_{i , j} \cdot MF}{{2}^{qbits}} )$$

$$where$$

$$MF = {2}^{qbits} \cdot \frac{PF}{Qstep}$$

$$and$$

$$qbits = 15 + floor ( \frac{QP}{6} )$$

The preceding equations can be implemented in integer arithmetic as follows, in which f is the quantization parameter rounding factor for the current macroblock, >>represents a binary shift right, and sgn(x) is 1 for x≧0 and −1 otherwise:

W_{i,j}′=((|W_{i,j}|·MF+f·2^{qbits})>>qbits)·sgn(W_{i,j})

In various embodiments, the entropy coding component 170 may be operative to perform entropy encoding in order to encode the output of the quantization/scaling component 160. In various embodiments, the entropy encoding may comprise one or more well-known entropy encoding techniques. The output of the entropy coding component 170 may comprise the output encoding of the current macroblock and may therefore comprise a portion of output video stream 104. The entropy coding component 170 may determine the total bits 175 representing the total number of bits used to encode the current macroblock.

In various embodiments, the ρ-domain analysis component 180 may be operative to determine an estimated total bits 185 for use by the rate control component 110. In various embodiments, one or more well-known ρ-domain analysis techniques may be used by the ρ-domain analysis component 180. It will be appreciated that the number of total bits 175 may vary with the use of different quantization parameter rounding factors. However, given that the linear mean absolute difference prediction and quantization parameters are not adjusted by the rounding offset adaptation component 150, it will be appreciated that this variation in the total bits 175 through the adjustment of the quantization parameter rounding factor 155 may not be properly accounted for by the rate control component 110 in determining the quantization parameter 115 for the next macroblock using the quadratic rate-quantization model. As such, in various embodiments, ρ-domain analysis is employed to produce an estimated total bits 185 that would have been produced had the default quantization parameter rounding factor been used. This ρ-domain analysis may comprise performing the quantization/scaling process a second time using the default quantization parameter rounding factor in order to determine the estimated total bits 185. In various embodiments, the ρ-domain analysis component 180 may be operative to use the determined quantization parameter rounding factor 155 and the total bits 175 to update ρ-domain analysis parameters while providing the estimated total bits 185 to the rate control component 110. In alternative embodiments, the ρ-domain analysis component 180 may be operative to use the estimated total bits and the default quantization parameter rounding factor to update the ρ-domain analysis parameters.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be needed for a novel implementation.

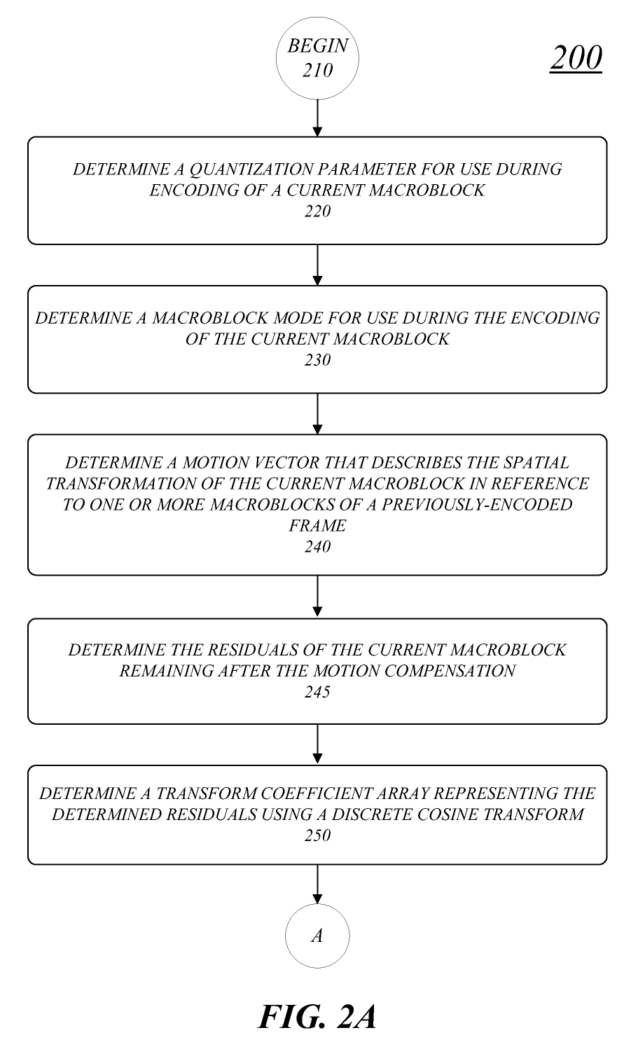

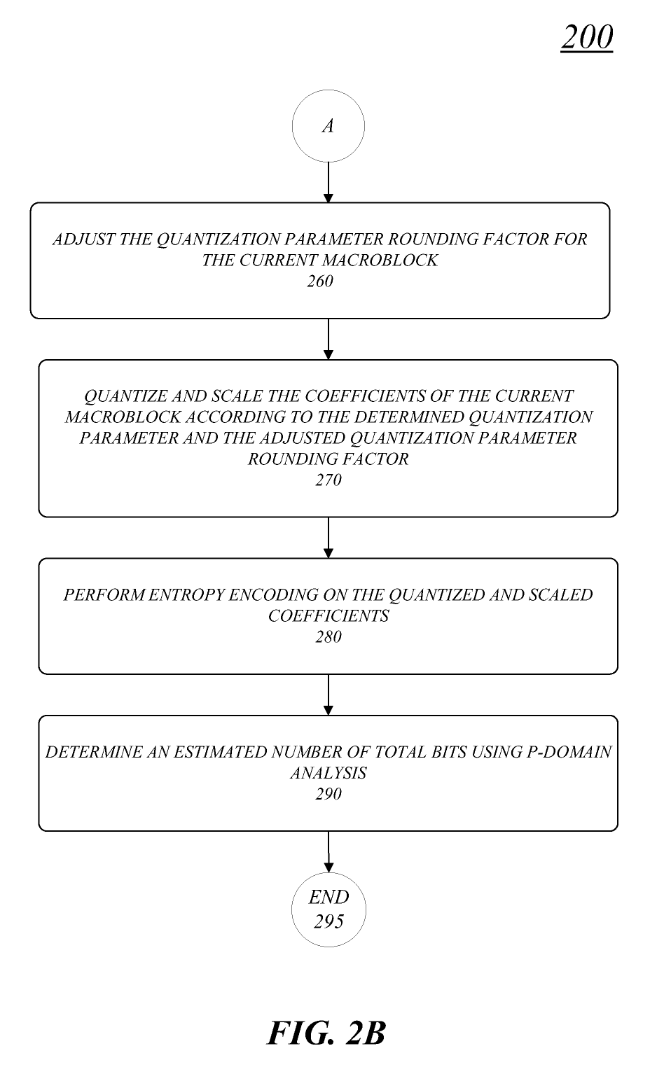

FIG. 2A illustrates one embodiment of a logic flow 200. The logic flow 200 may be representative of some or all of the operations executed by one or more embodiments described herein.

The operations recited in logic flow 200 may be embodied as computer-readable and computer-executable instructions that reside, for example, in data storage features such as a computer usable volatile memory, a computer usable non-volatile memory, and/or data storage unit. The computer-readable and computer-executable instructions may be used to control or operate in conjunction with, for example, a processor and/or processors. Although the specific operations disclosed in logic flow 200 may be embodied as such instructions, such operations are exemplary. That is, the instructions may be well suited to performing various other operations or variations of the operations recited in logic flow 200. It is appreciated that instructions embodying the operations in logic flow 200 may be performed in an order different than presented, and that not all of the operations in logic flow 200 may be performed.

In operation 210, operations for the logic flow 200 are initiated.

In operation 215, one or more parameters are received for use during the encoding. These one or more parameters may be used during the encoding of a video stream by the video encoding system 100. These parameters may comprise one or more model parameters, a bit rate budget for the encoding, and one or more user-defined parameters. These parameters may be specified at the initiation of the encoding process by a user in order to control the encoding process.

In operation 220, a quantization parameter 115 for use during the encoding of a current macroblock is determined. In various embodiments, a linear mean absolute difference (MAD) model may be employed to predict the coding complexity. Given the coding complexity and a target number of output bits, a quadratic rate-quantization model may be employed to calculate the quantization parameter 115. In various embodiments, the quantization parameter 115 may be determined according to a predicted linear mean absolute difference of the current macroblock, a target number of output bits, and a first and second model parameter. The model parameters may be iteratively adjusted during the encoding of an input video stream in order to meet the bit rate budget of the video stream encoding process. The model parameters may be adjusted according to the quantization parameter, the linear mean absolute difference (MAD) model, and a total number of output bits output during the encoding of the previous macroblock. Alternatively, the model parameters may be adjusted according to the quantization parameter, the linear mean absolute difference (MAD) model, and an estimated total number of output bits output as estimated by ρ-domain analysis during the encoding of the previous macroblock. In various embodiments, the bit rate budget of the encoding may comprise a maximum sustained bit rate, a maximum peak bit rate, a maximum total bit size, or any other means of specifying a bit rate budget for a macroblock or frame. A bit rate budget for a current frame of the input video stream being compressed may be determined, which may comprise the target number of output bits for the current frame.

In operation 230, a macroblock mode 125 for use during the encoding of the current macroblock is determined. In some embodiments, the macroblock mode 125 may comprise one of an intra mode or an inter mode. An intra mode may comprise a mode using intra prediction, in which a macroblock is encoded using only the video data of that particular macroblock and previously-encoded macroblocks of the current frame, without reference to the video data of macroblocks belonging to any other frame. An inter mode may comprise a mode using inter prediction, in which the prediction of the frame is directly based on the video data of a macroblock belonging to another frame. In various embodiments, the macroblock mode 125 may be determined using the determined quantization parameter 115 to meet a particular bit rate budget. The bit rate budget for the current frame may be determined using the total bit rate budget for the encoding.

In operation 240, a motion vector that describes the spatial transformation of the current macroblock in reference to one or more macroblocks of a previously-encoded frame is determined. The motion vector may be determined using the determined macroblock mode. In various embodiments, one or more well-known motion estimation/motion compensation techniques may be used to generate the motion vector.

In operation 245, the residuals 135 of the current macroblock remaining after the motion compensation are determined.

In operation 250, a transform coefficient array representing the determined residuals is determined using a discrete cosine transformation. The coefficients 145 may comprise a transform coefficient array representing the residuals 135 in terms of the sum of cosine functions of different frequencies. In various embodiments, one or more well-known discrete cosine transform techniques may be used to generate the coefficient 145.

FIG. 2B continues to illustrates one embodiment of a logic flow 200. The logic flow 200 may be representative of some or all of the operations executed by one or more embodiments described herein. The logic flow 200 may continue in FIG. 2B at identifier A.

In operation 260, the quantization parameter rounding factor for the current macroblock is adjusted. The quantization parameter rounding factor 155 may be adjusted in order to meet a bit rate budget. In various embodiments, the quantization parameter rounding factor 155 may be adjusted in order to meet the bit rate budget by manipulating the size of a dead zone of the current macroblock. The size of the dead zone may be increased by increasing the value of the quantization parameter rounding factor 155. The size of the dead zone may be decreased by decreasing the value of the quantization parameter rounding factor 155. The dead zone of a macroblock may refer to the portion of the macroblock with zero-value coefficients after quantization.

In various embodiments, the quantization parameter rounding factor for the current macroblock may be selected from a specified list of possible quantization parameter rounding factors. The specified list of possible quantization parameter rounding factors may be determined by the macroblock mode 125. The list of possible quantization parameter rounding factors may be determined, additionally or alternatively, by the resolution of the frame being compressed. If the frame being compressed is of a high resolution and the macroblock mode 125 is an intra mode then the list of possible quantization parameter rounding factors may be

$$\{ \frac{1}{3} , \frac{7}{24} , \frac{1}{4} , \frac{5}{24} \} .$$

If the frame being compressed is of a high resolution and the macroblock mode 125 is an inter mode then the list of possible quantization parameter rounding factors may be

$$\{ \frac{1}{6} , \frac{1}{8} , \frac{1}{12} , \frac{1}{24} \} .$$

If the frame being compressed is of a low resolution and the macroblock mode 125 is an intra mode then the list of possible quantization parameter rounding factors may be

$$\{ \frac{1}{3} , \frac{7}{24} , \frac{1}{4} \} .$$

If the frame being compressed is of a low resolution and the macroblock mode 125 is an inter mode then the list of possible quantization parameter rounding factors may be

$$\{ \frac{1}{6} , \frac{1}{8} , \frac{1}{12} \} .$$

In various embodiments, a high resolution may comprise any resolution greater or equal to the video graphics array (VGA) resolution of 640×480 pixels. In various embodiments, a low resolution may comprise any resolution lesser or equal to the common intermediate format (CIF) resolution of 352×288 pixels. These specified lists of possible quantization parameter rounding factors have been determined as an efficient mode of operation of the enclosed embodiments as determined through experimentation with different quantization parameter rounding factors.

In various embodiments, the quantization parameter rounding factor 155 for all macroblocks of the current frame may be equal to the average quantization parameter rounding factor for the previous frame if the quantization parameter for the current frame is equal to a quantization parameter for the previous frame plus or minus a specified maximum quantization parameter adjustment value. In various embodiments, the maximum quantization parameter adjustment value may be specified as a user input to the encoding process or may be a value hard-coded into the video encoding system 100.

A previous quantization parameter rounding factor may be used to adjust the quantization parameter rounding factor 155. The previous quantization parameter rounding factor may comprise the quantization parameter rounding factor used for compressing the macroblock immediately previous to the current macroblock. A count of the number of preceding macroblocks may be used to adjust the quantization parameter rounding factor 155. The count of the number of preceding macroblocks may comprise a count of how many macroblocks from the current frame have already been compressed at the time that the current macroblock is being analyzed by the described method. The analysis of the current macroblock may involve a total number of output bits generated during compression of already-compressed macroblocks from the current frame, a total number of macroblocks for the current frame, and a first and second user-defined parameter.

In various embodiments, if the total number of output bits generated during compression of already-compressed macroblocks from the current frame plus the first user-defined parameter is less than the number of preceding macroblocks multiplied by the target number of output bits divided by the total number of macroblocks for the current frame then the quantization parameter rounding factor is selected from a specified list of possible quantization parameter rounding factors such that the selected quantization parameter rounding factor is next-smallest with respect to the previous quantization parameter rounding factor. It will be appreciated that this is effectively a comparison between the number of output bits used so far for the encoding of the current frame and an estimated number of output bits that should have been used so far for the encoding of the current frame. If the actual output bits used is less than the estimated target then additional capacity exists in the bit rate budget for the current macroblock and any remaining macroblocks in the current frame. As such, the next-smallest quantization parameter rounding factor is used, decreasing distortion from the quantization as previously discussed. The first user-defined parameter is added to the actual output bits used to prevent the bit rate usage from being increased unless a sufficient buffer of additional output bits are available in the bit rate budget.

In various embodiments, if the total number of output bits generated during compression of already-compressed macroblocks from the current frame plus the second user-defined parameter is greater than the number of preceding macroblocks multiplied by the target number of output bits divided by the total number of macroblocks for the current frame then the quantization parameter rounding factor is selected from the specified list of possible quantization parameter rounding factors such that the selected quantization parameter rounding factor is next-largest with respect to the previous quantization parameter rounding factor. It will be appreciated that, as before, this is effectively a comparison between the number of output bits used so far for the encoding of the current frame and an estimated number of output bits that should have been used so far for the encoding of the current frame. If the actual output bits used is greater than the estimated target then the bit rate budget may be being used faster than desired, which may require the current macroblock and any remaining macroblocks in the current frame to be encoded using less bits in order to meet the bit rate budget. As such, the next-largest quantization parameter rounding factor is used, decreasing the bits needed to store the quantized coefficients as previously discussed. The second user-defined parameter is added to the actual output bits used to prevent the bit rate usage from being decreased unless a sufficient demand of output bits is needed to meet the bit rate budget.

In various embodiments, if neither of the preceding conditionals is true, then a default quantization parameter rounding factor is used if the current macroblock is the first macroblock of the current frame and the current frame is the first frame of the video stream, and the previous quantization parameter rounding factor is used otherwise. It will be appreciated that this may allow for quantization to proceed at the current balance between bit rate and distortion by not changing the quantization parameter rounding factor as the actual number of output bits used is within an acceptable range of bit range usage as determined by the estimated number of output bits and the first and second user-defined parameters.

In operation 270, the coefficients of the current macroblock are quantized and scaled according to the determined quantization parameter 115 and the adjusted quantization parameter rounding factor 155. In various embodiments, the quantization may comprise one or more well-known quantization techniques. In various embodiments, the quantization may be defined by the following equations, in which W_{i,j} is the coefficients 145, K_{i,j}′ is the output of the quantization/scaling component 160, QP is the quantization parameter of the current macroblock, and Qstep is the quantization step size:

$${W}_{i , j}^{′} = round ( \frac{{W}_{i , j} \cdot MF}{{2}^{qbits}} )$$

$$where$$

$$MF = {2}^{qbits} \cdot \frac{PF}{Qstep}$$

$$and$$

$$qbits = 15 + floor ( \frac{QP}{6} )$$

The preceding equations can be implemented in integer arithmetic as follows, in which f is the quantization parameter rounding factor for the current macroblock, >>represents a binary shift right, and sgn(x) is 1 for x≧0 and −1 otherwise:

W_{i,j}′=((|W_{i,j}|·MF+f·2^{qbits})>>qbits)·sgn(W_{i,j})

In operation 280, entropy encoding is performed on the quantized and scaled coefficients. In various embodiments, the entropy encoding may comprise one or more well-known entropy encoding techniques. The output of the entropy coding may comprise the output encoding of the current macroblock and may therefore comprise a portion of output video stream 104. The total bits 175 may be determined, representing the total number of bits used to encode the current macroblock.

In operation 290, an estimated number of total bits 185 is determined using ρ-domain analysis. In various embodiments, one or more well-known ρ-domain analysis techniques may be used to perform the ρ-domain analysis. It will be appreciated that the number of total bits 175 may vary with the use of different quantization parameter rounding factors. However, given that the linear mean absolute difference prediction and quantization parameters are not adjusted during the determination of the quantization parameter rounding offset, it will be appreciated that this variation in the total bits 175 through the adjustment of the quantization parameter rounding factor 155 may not be properly accounted for in determining the quantization parameter 115 for the next macroblock using the quadratic rate-quantization model during the next iteration of operation 210. As such, in various embodiments, ρ-domain analysis is employed to produce an estimated total bits 185 that would have been produced had the default quantization parameter rounding factor been used instead of the adjusted quantization parameter rounding factor actually used. This ρ-domain analysis may comprise performing the quantization/scaling process a second time using the default quantization parameter rounding factor in order to determine the estimated total bits 185. In various embodiments, the determined quantization parameter rounding factor 155 and the total bits 175 may be used to update ρ-domain analysis parameters while the estimated total bits 185 are provided for the rate control operation 210. In alternative embodiments, the estimated total bits and the default quantization parameter rounding factor may be used to update the ρ-domain analysis parameters.

In operation 295, operations for the logic flow 200 are terminated.

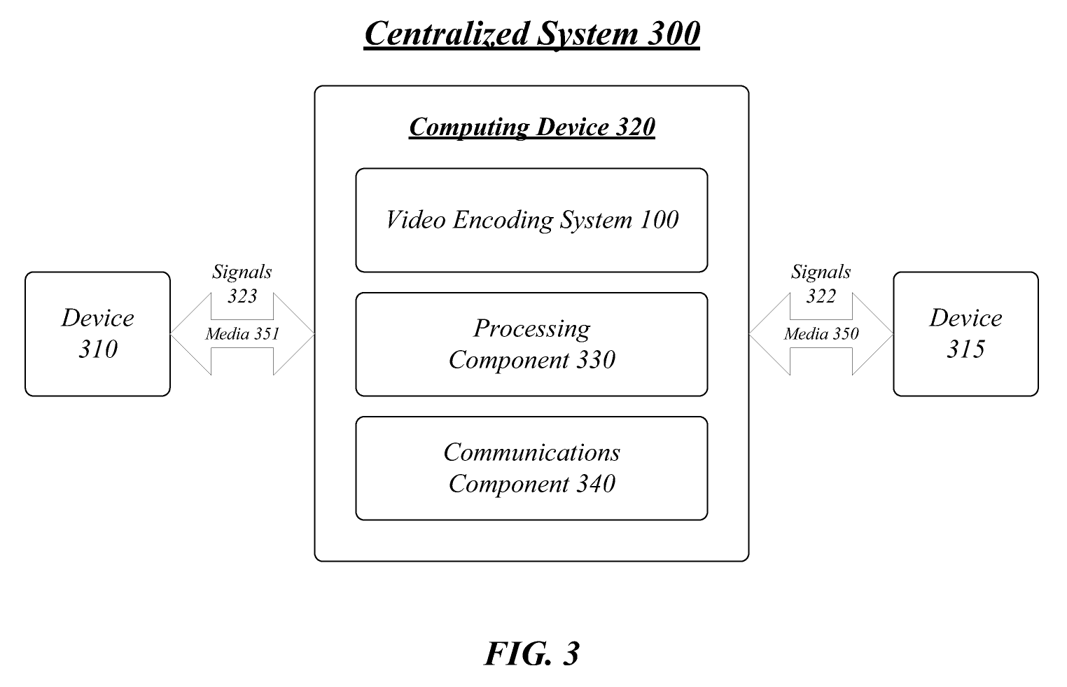

FIG. 3 illustrates a block diagram of a centralized system 300. The centralized system 300 may implement some or all of the structure and/or operations for the video encoding system 100 in a single computing entity, such as entirely within a single computing device 320.

The computing device 320 may execute processing operations or logic for the video encoding system 100 using a processing component 330. The processing component 330 may comprise various hardware elements, software elements, or a combination of both. Examples of hardware elements may include devices, logic devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing device 320 may execute communications operations or logic for the system 100 using communications component 340. The communications component 340 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 340 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 350, 351 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media 350, 351.

The computing device 320 may communicate with other devices 310, 315 over respective communications media 351, 350 using respective communications signals 323, 322 via the communications component 340.

In various embodiments, and in reference to FIG. 1, processing component 330 may comprise all or some of rate control component 110, rate distortion optimization component 120, motion estimation/motion compensation component 130, discrete cosine transform component 140, rounding offset adaptation component 150, quantization/scaling component 160, entropy coding component 170, and ρ-domain analysis component 180.

In various embodiments, and in reference to FIG. 1, communications component 340 may be used to receive input video stream 102. In various embodiments, and in reference to FIG. 1, communications component 340 may be used to transmit output video stream 104. In various embodiments, device 310 may correspond to a user device, server, or other video source providing input video stream 102 to the video encoding system 100. In various embodiments, signals 323 transmitted over media 351 may comprise the transmission of input video stream 102 to the video encoding system 100. In various embodiments, device 315 may correspond to a user device, server, or other video viewing device or storage device receiving output video stream 104 from the video encoding system 100. In various embodiments, signals 322 transmitted over media 350 may comprise the transmission of output video stream 104 to a destination video device. In various embodiments, communications component 340 may comprise a video server component for a video streaming service. In various embodiments, communications component 340 may be operative to stream output video stream 104 to a plurality of viewing devices.

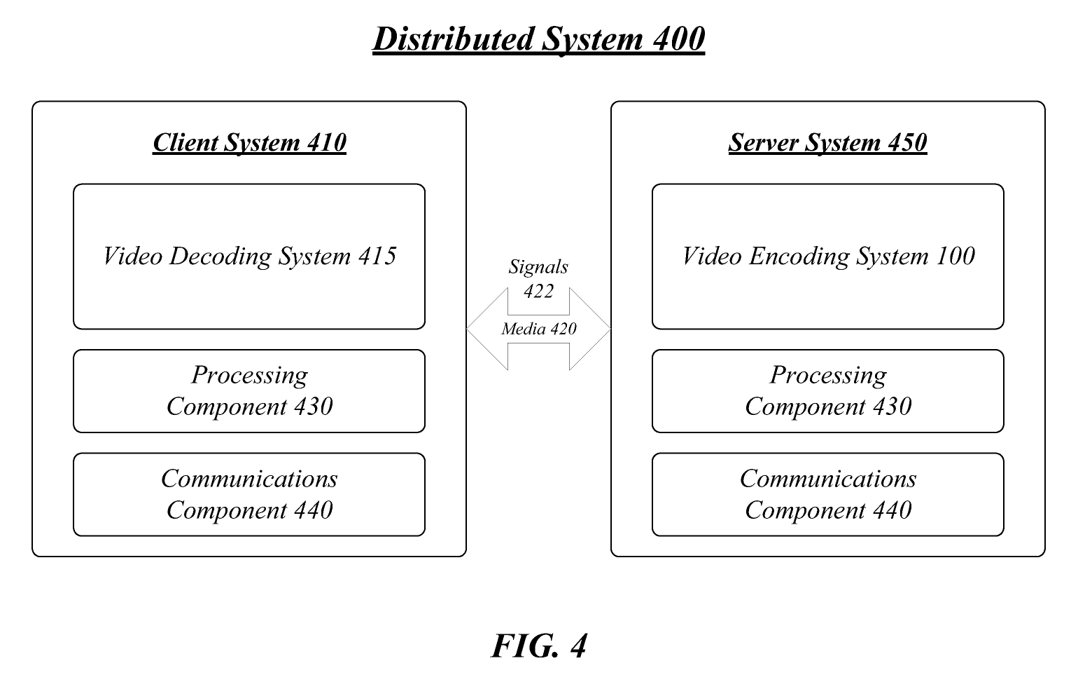

FIG. 4 illustrates a block diagram of a distributed system 400. The distributed system 400 may distribute portions of the structure and/or operations for the systems 100, 300 across multiple computing entities. Examples of distributed system 400 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The client system 410 and the server system 450 may process information using the processing components 430, which are similar to the processing component 330 described with reference to FIG. 3. The client system 410 and the server system 450 may communicate with each over a communications media 420 using communications signals 422 via communications components 440, which are similar to the communications component 340 described with reference to FIG. 3.

In one embodiment, for example, the distributed system 400 may be implemented as a client-server system. A client system 410 may implement the devices 310 or 315. A server system 450 may implement the rate control component 110, rate distortion optimization component 120, motion estimation/motion compensation component 130, discrete cosine transform component 140, rounding offset adaptation component 150, quantization/scaling component 160, entropy coding component 170, and ρ-domain analysis component 180.

In various embodiments, server system 450 may comprise video encoding system 100. In various embodiments, processing component 430 may comprise all or some of rate control component 110, rate distortion optimization component 120, motion estimation/motion compensation component 130, discrete cosine transform component 140, rounding offset adaptation component 150, quantization/scaling component 160, entropy coding component 170, and ρ-domain analysis component 180.

In various embodiments, the server system 450 may comprise or employ one or more server computing devices and/or server programs that operate to perform various methodologies in accordance with the described embodiments. For example, when installed and/or deployed, a server program may support one or more server roles of the server computing device for providing certain services and features. Exemplary server systems 450 may include, for example, stand-alone and enterprise-class server computers operating a server OS such as a MICROSOFT® OS, a UNIX® OS, a LINUX® OS, or other suitable server-based OS. Exemplary server programs may include, for example, communications server programs such as Microsoft® Office Communications Server (OCS) for managing incoming and outgoing messages, messaging server programs such as Microsoft® Exchange Server for providing unified messaging (UM) for e-mail, voicemail, VoIP, instant messaging (IM), group IM, enhanced presence, and audio-video conferencing, and/or other types of programs, applications, or services in accordance with the described embodiments.

In various embodiments, communications component 440 may be used to receive input video stream 102. In various embodiments, communications component 440 may be used to transmit output video stream 104. In various embodiments, signals 422 transmitted on media 420 may comprise output video stream 104. In various embodiments, server system 450 may comprise a video server operative to encode input video stream 102 according to a defined video encoding codec, such as H.264, and transmit the encoded video stream as output video stream 104 using communications component 440.

In various embodiments, the client system 410 may comprise or employ one or more client computing devices and/or client programs that operate to perform various methodologies in accordance with the described embodiments. In various embodiments, client system 410 may comprise a video decoding system 415. In various embodiments, client system 410 may use communications component 440 to receive output video stream 104 over media 420 as signals 422. In various embodiments, video decoding system 415 may be operative to use processing component 430 to decode the received output video stream 104. In various embodiments, video decoding system may be operative to decode the received output video stream 104 according to a defined video encoding codec, such as H.264, using processing component 430.

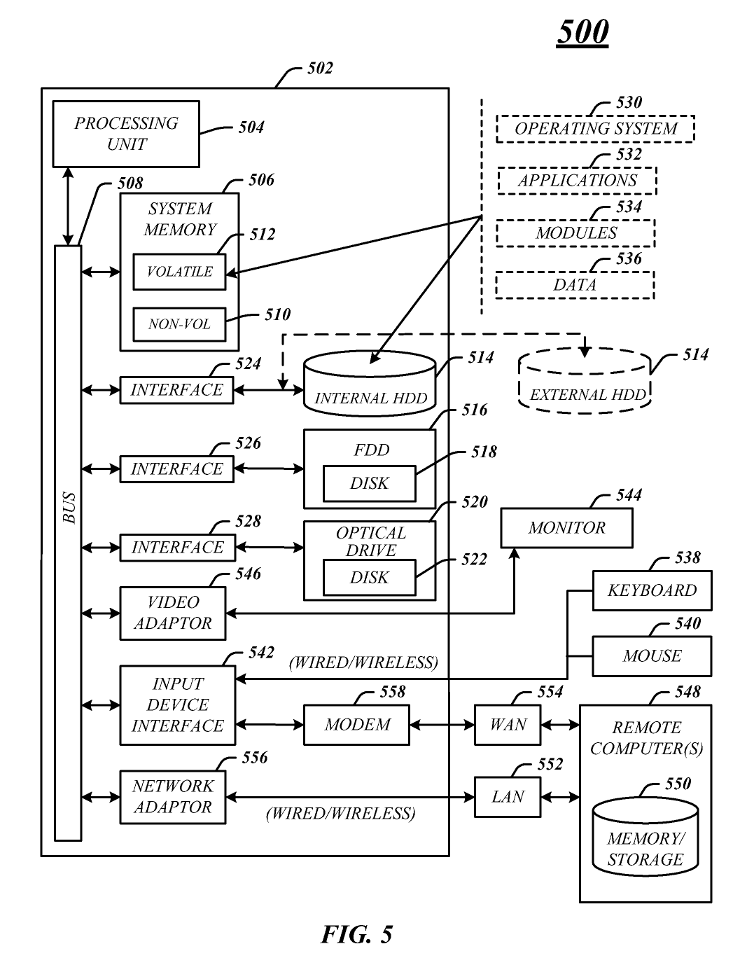

FIG. 5 illustrates an embodiment of an exemplary computing architecture 500 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 500 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 500 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 500.

As shown in FIG. 5, the computing architecture 500 comprises a processing unit 504, a system memory 506 and a system bus 508. The processing unit 504 can be any of various commercially available processors. Dual microprocessors and other multi-processor architectures may also be employed as the processing unit 504. The system bus 508 provides an interface for system components including, but not limited to, the system memory 506 to the processing unit 504. The system bus 508 can be any of several types of bus structure that may further interconnect to a memory bus (with or without a memory controller), a peripheral bus, and a local bus using any of a variety of commercially available bus architectures.

The computing architecture 500 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 5, the system memory 506 can include non-volatile memory 510 and/or volatile memory 512. A basic input/output system (BIOS) can be stored in the non-volatile memory 510.

The computer 502 may include various types of computer-readable storage media in the form of one or more lower speed memory units, including an internal hard disk drive (HDD) 514, a magnetic floppy disk drive (FDD) 516 to read from or write to a removable magnetic disk 518, and an optical disk drive 520 to read from or write to a removable optical disk 522 (e.g., a CD-ROM or DVD). The HDD 514, FDD 516 and optical disk drive 520 can be connected to the system bus 508 by a HDD interface 524, an FDD interface 526 and an optical drive interface 528, respectively. The HDD interface 524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 510, 512, including an operating system 530, one or more application programs 532, other program modules 534, and program data 536.

The one or more application programs 532, other program modules 534, and program data 536 can include, for example, the rate control component 110, rate distortion optimization component 120, motion estimation/motion compensation component 130, discrete cosine transform component 140, rounding offset adaptation component 150, quantization/scaling component 160, entropy coding component 170, and ρ-domain analysis component 180.

A user can enter commands and information into the computer 502 through one or more wire/wireless input devices, for example, a keyboard 538 and a pointing device, such as a mouse 540. Other input devices may include a microphone, an infra-red (IR) remote control, a joystick, a game pad, a stylus pen, touch screen, or the like. These and other input devices are often connected to the processing unit 504 through an input device interface 542 that is coupled to the system bus 508, but can be connected by other interfaces such as a parallel port, IEEE 1394 serial port, a game port, a USB port, an IR interface, and so forth.

A monitor 544 or other type of display device is also connected to the system bus 508 via an interface, such as a video adaptor 546. In addition to the monitor 544, a computer typically includes other peripheral output devices, such as speakers, printers, and so forth.

The computer 502 may operate in a networked environment using logical connections via wire and/or wireless communications to one or more remote computers, such as a remote computer 548. The remote computer 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wire/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wire and/or wireless device, connects to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

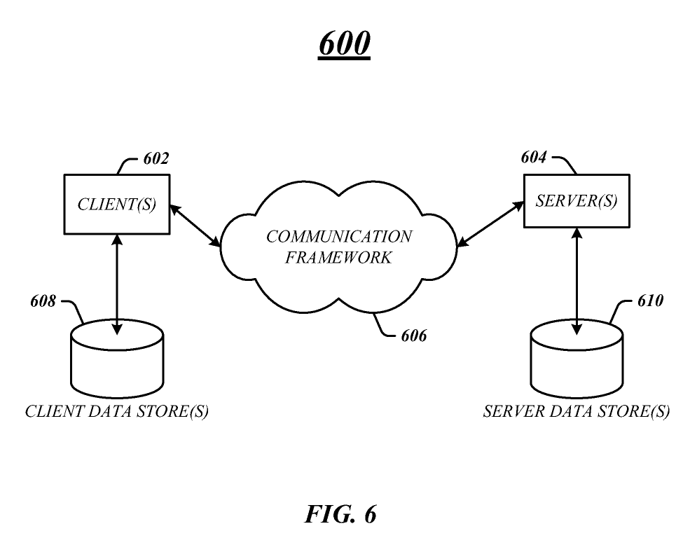

FIG. 6 illustrates a block diagram of an exemplary communications architecture 600 suitable for implementing various embodiments as previously described. The communications architecture 600 includes various common communications elements, such as a transmitter, receiver, transceiver, radio, network interface, baseband processor, antenna, amplifiers, filters, and so forth. The embodiments, however, are not limited to implementation by the communications architecture 600.

As shown in FIG. 6, the communications architecture 600 comprises includes one or more clients 602 and servers 604. The clients 602 may implement the client systems 310, 315, and 410. The servers 604 may implement the server system 450. The clients 602 and the servers 604 are operatively connected to one or more respective client data stores 608 and server data stores 610 that can be employed to store information local to the respective clients 602 and servers 604, such as cookies and/or associated contextual information.

The clients 602 and the servers 604 may communicate information between each other using a communication framework 606. The communications framework 606 may implement any well-known communications techniques and protocols, such as those described with reference to systems 300, 400 and 500. The communications framework 606 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic device; and
a rounding offset adaptation component operative on the logic device to adjust a quantization parameter rounding factor for a current macroblock of a current frame of a video stream being compressed by a video encoding system.

2. The apparatus of claim 1, comprising a rate control component operative to determine a bit rate budget for the current frame, the rounding offset adaptation component operative to adjust the quantization parameter rounding factor in order to meet the bit rate budget.

3. The apparatus of claim 2, the rounding offset adaptation component operative to adjust the quantization parameter rounding factor in order to meet the bit rate budget by manipulating a size of a dead zone of the current macroblock.

4. The apparatus of claim 1, wherein the quantization parameter rounding factor for all macroblocks of the current frame is equal to an average quantization parameter rounding factor for a previous frame if the quantization parameter for the current frame is equal to a quantization parameter for the previous frame plus or minus a specified maximum quantization parameter adjustment value.

5. The apparatus of claim 2, comprising a rate-distortion optimization component operative to determine a macroblock mode, wherein the quantization parameter rounding factor is selected from a specified list of possible quantization parameter rounding factors, the specified list determined by the determined macroblock mode.

6. The apparatus of claim 5, the bit rate budget comprising a target number of output bits for the current frame, a previous quantization parameter rounding factor comprising a quantization parameter rounding factor used for compressing a macroblock immediately previous to the current macroblock, a number of preceding macroblocks comprising a count of how many macroblocks from the current frame have already been compressed, wherein if a total number of output bits generated during compression of already-compressed macroblocks from the current frame plus a first user-defined parameter is less than the number of preceding macroblocks multiplied by the target number of output bits divided by a total number of macroblocks for the current frame then the quantization parameter rounding factor is selected from the specified list of possible quantization parameter rounding factors such that the selected quantization parameter rounding factor is next-smallest with respect to the previous quantization parameter rounding factor.

7. The apparatus of claim 6, wherein if the total number of output bits generated during compression of already-compressed macroblocks from the current frame plus a second user-defined parameter is greater than the number of preceding macroblocks multiplied by the target number of output bits divided by the total number of macroblocks for the current frame then the quantization parameter rounding factor is selected from the specified list of possible quantization parameter rounding factors such that the selected quantization parameter rounding factor is next-largest with respect to the previous quantization parameter rounding factor.

8. The apparatus of claim 7, wherein if neither of the conditionals is true, then a default quantization parameter rounding factor is used if the current macroblock is a first macroblock of the current frame and the current frame is a first frame of the video stream, and the previous quantization parameter rounding factor is used otherwise.

9. The apparatus of claim 5, wherein the frame being compressed is of a high resolution and the specified list of possible quantization parameter rounding factors is
$$\{ \frac{1}{3} , \frac{7}{24} , \frac{1}{4} , \frac{5}{24} \}$$
if the macroblock mode is an intra mode and
$$\{ \frac{1}{6} , \frac{1}{8} , \frac{1}{12} , \frac{1}{24} \}$$
if the macroblock mode is an inter mode.

10. The apparatus of claim 5, wherein the frame being compressed is of a low resolution and the specified list of possible quantization parameter rounding factors is
$$\{ \frac{1}{3} , \frac{7}{24} , \frac{1}{4} \}$$
if the macroblock mode is an intra mode and
$$\{ \frac{1}{6} , \frac{1}{8} , \frac{1}{12} \}$$
if the macroblock mode is an inter mode.

11. A method comprising:
determining a quantization parameter for use during the encoding of a current macroblock of a current frame of a video stream being compressed by a video encoding system;
adjusting a quantization parameter rounding factor for a current macroblock; and
quantizing and scaling coefficients of the current macroblock according to the determined quantization parameter and the adjusted quantization parameter rounding factor.

12. The method of claim 11, comprising determining a bit rate budget for the current frame, wherein the quantization parameter rounding factor is adjusted in order to meet the bit rate budget.

13. The method of claim 12, comprising adjusting the quantization parameter rounding factor in order to meet the bit rate budget by manipulating a size of a dead zone of the current macroblock.

14. The method of claim 12, comprising determining a macroblock mode, the quantization parameter rounding factor selected from a specified list of possible quantization parameter rounding factors, the specified list determined by the determined macroblock mode, the bit rate budget comprising a target number of output bits for the current frame, a previous quantization parameter rounding factor comprising a quantization parameter rounding factor used for compressing a macroblock immediately previous to the current macroblock, a number of preceding macroblocks comprising a count of how many macroblocks from the current frame have already been compressed, wherein:
the quantization parameter rounding factor for all macroblocks of the current frame is equal to an average quantization parameter rounding factor for a previous frame if the quantization parameter for the current frame is equal to a quantization parameter for the previous frame plus or minus a specified maximum quantization parameter adjustment value;
if a total number of output bits generated during compression of already-compressed macroblocks from the current frame plus a first user-defined parameter is less than the number of preceding macroblocks multiplied by the target number of output bits divided by a total number of macroblocks for the current frame then the quantization parameter rounding factor is selected from the specified list of possible quantization parameter rounding factors such that the selected quantization parameter rounding factor is next-smallest with respect to the previous quantization parameter rounding factor;
if the total number of output bits generated during compression of already-compressed macroblocks from the current frame plus a second user-defined parameter is greater than the number of preceding macroblocks multiplied by the target number of output bits divided by the total number of macroblocks for the current frame then the quantization parameter rounding factor is selected from the specified list of possible quantization parameter rounding factors such that the selected quantization parameter rounding factor is next-largest with respect to the previous quantization parameter rounding factor; and
otherwise a default quantization parameter rounding factor is used if the current macroblock is a first macroblock of the current frame and the current frame is a first frame of the video stream and the previous quantization parameter rounding factor is used otherwise.

15. The method of claim 14, wherein if the frame being compressed is of a high resolution then the specified list of possible quantization parameter rounding factors is
$$\{ \frac{1}{3} , \frac{7}{24} , \frac{1}{4} , \frac{5}{24} \}$$
if the macroblock mode is an intra mode and
$$\{ \frac{1}{6} , \frac{1}{8} , \frac{1}{12} , \frac{1}{24} \}$$
if the macroblock mode is an inter mode, and if the frame being compressed is of a low resolution then the specified list of possible quantization parameter rounding factors is
$$\{ \frac{1}{3} , \frac{7}{24} , \frac{1}{4} \}$$
it the macroblock mode is an intra mode and
$$\{ \frac{1}{6} , \frac{1}{8} , \frac{1}{12} \}$$
if the macroblock mode is an inter mode.

16. An article of manufacture comprising a storage medium containing instructions that when executed enable a system to:
adjust a quantization parameter rounding factor for a current macroblock of a current frame of a video stream being compressed by a video encoding system; and
determine an estimated number of total bits using ρ-domain analysis, the estimated number of total bits comprising a number of bits that would have been produced had a default quantization parameter rounding factor been used for encoding the current macroblock instead of the adjusted quantization parameter rounding factor.

17. The article of manufacture of claim 16, comprising instructions that when executed enable a system to determine a bit rate budget for the current frame, wherein the quantization parameter rounding factor is adjusted in order to meet the bit rate budget.

18. The article of manufacture of claim 17, wherein the quantization parameter rounding factor is adjusted in order to meet the bit rate budget by manipulating a size of a dead zone of the current macroblock.

19. The article of manufacture of claim 17, comprising instructions that when executed enable a system to determine a macroblock mode, the quantization parameter rounding factor selected from a specified list of possible quantization parameter rounding factors, the specified list determined by the determined macroblock mode, the bit rate budget comprising a target number of output bits for the current frame, a previous quantization parameter rounding factor comprising a quantization parameter rounding factor used for compressing a macroblock immediately previous to the current macroblock, a number of preceding macroblocks comprising a count of how many macroblocks from the current frame have already been compressed, wherein:
the quantization parameter rounding factor for all macroblocks of the current frame is equal to an average quantization parameter rounding factor for a previous frame if the quantization parameter for the current frame is equal to a quantization parameter for the previous frame plus or minus a specified maximum quantization parameter adjustment value;
if a total number of output bits generated during compression of already-compressed macroblocks from the current frame plus a first user-defined parameter is less than the number of preceding macroblocks multiplied by the target number of output bits divided by a total number of macroblocks for the current frame then the quantization parameter rounding factor is selected from the specified list of possible quantization parameter rounding factors such that the selected quantization parameter rounding factor is next-smallest with respect to the previous quantization parameter rounding factor;
if the total number of output bits generated during compression of already-compressed macroblocks from the current frame plus a second user-defined parameter is greater than the number of preceding macroblocks multiplied by the target number of output bits divided by the total number of macroblocks for the current frame then the quantization parameter rounding factor is selected from the specified list of possible quantization parameter rounding factors such that the selected quantization parameter rounding factor is next-largest with respect to the previous quantization parameter rounding factor; and
otherwise the default quantization parameter rounding factor is used if the current macroblock is a first macroblock of the current frame and the current frame is a first frame of the video stream and the previous quantization parameter rounding factor is used otherwise.

20. The article of manufacture of claim 19, wherein if the frame being compressed is of a high resolution then the specified list of possible quantization parameter rounding factors is
$$\{ \frac{1}{3} , \frac{7}{24} , \frac{1}{4} , \frac{5}{24} \}$$
if the macroblock mode is an intra mode and
$$\{ \frac{1}{6} , \frac{1}{8} , \frac{1}{12} , \frac{1}{24} \}$$
it the macroblock mode is an inter mode, and if the frame being compressed is of a low resolution then the specified list of possible quantization parameter rounding factors is
$$\{ \frac{1}{3} , \frac{7}{24} , \frac{1}{4} \}$$
if the macroblock mode is an intra mode and
$$\{ \frac{1}{6} , \frac{1}{8} , \frac{1}{12} \}$$
if the macroblock mode is an inter mode.
